(19) United States
(12) Patent Application Publication
(10) Pub. No.: US 2024/0259303 A1
(43) Pub. Date: Aug. 1, 2024

(54) ROUTING METHODS, SYSTEMS ON CHIPS, AND ELECTRONIC APPARATUSES

(71) Applicant: Samsung Electronics Co., Ltd., Suwon-si (KR)

(72) Inventors: Jungsoo Kim, Suwon-si (KR); Hyunjoon Yoo, Suwon-si (KR); Bumjun Kim, Suwon-si (KR); Mehee Yun, Suwon-si (KR); Sang-Hwa Jin, Suwon-si (KR)

(21) Appl. No.: 18/352,497

(22) Filed: Jul. 14, 2023

(30) Foreign Application Priority Data
Jan. 30, 2023 (KR) 10-2023-0011665

(51) Int. Cl. H04L 45/00; H04L 45/302; H04L 47/2425

(52) U.S. Cl. CPC H04L 45/38; G06F 13/4226; H04L 45/3065; H04L 47/2433; G06F 2213/0026

(57) ABSTRACT

A routing method that may be performed by a system on chip of a backplane that is connected between a plurality of hosts and a plurality of devices. The routing method may include: monitoring traffic of the plurality of devices; determining mode types of the plurality of devices according to the monitored traffic; and performing routing to allocate lanes between the plurality of devices and the backplane according to the mode types.

### CROSS-REFERENCE TO RELATED APPLICATION

This application claims priority to and the benefit of Korean Patent Application No. 10-2023-0011665 filed in the Korean Intellectual Property Office on Jan. 30, 2023, and the entire contents of the above-identified application are incorporated herein by reference.

### BACKGROUND

### (a) Field

The present disclosure relates to routing methods, systems on chips, and electronic devices or electronic apparatuses.

### (b) Description of the Related Art

Due to increasing use of specialized workloads such as compression, encryption, and artificial intelligence, and due to corresponding rapid increases of data, demand is increasing for heterogeneous computing in which an accelerator developed for a special purpose works together with a general-purpose processor. The accelerator may use or require a high performance connection to the processor, and may share (e.g., may preferably share or may ideally share) a memory space in order to reduce overhead and latency.

Therefore, along with research on inter-chip interconnection protocols that maintain memory and cache coherency by connecting processors to various accelerators, application technologies such as installing separate functions or increasing memory are being researched.

### SUMMARY

Some embodiments may provide routing methods that are adaptive in scenarios in which an inter-chip interconnection protocol is used. Some embodiments may provide systems on chips and electronic devices that perform or are configured to perform one or more of the routing methods.

For example, an embodiment may provide a routing method that is performed by a system on chip of a backplane connected between a plurality of hosts and a plurality of devices. The routing method may include: monitoring traffic of the plurality of devices; determining mode types of the plurality of devices according to the monitored traffic; and performing routing according to the mode types to allocate lanes between the plurality of devices and the backplane.

The determining of the mode types may include determining a mode for each device of the plurality of devices to be a first mode or a second mode according to the traffic, and at least one of a link speed and a link width supported by the first mode may be greater than or equal to at least one of a link speed and a link width supported by the second mode.

The plurality of hosts may include a first host and a second host, and the determining of the mode types for the plurality of hosts of a first device of the plurality of devices may include: determining a mode type for the first host of the first device; and determining a mode type for the second host of the first device.

The performing of the routing may include: determining a number of lanes to be allocated to each device of the plurality of devices according to the mode type determined therefor; and changing lanes of the plurality of devices according to the determined number of lanes.

The determining of the number of lanes may include increasing a number of lanes to be allocated to a device of a higher mode or decreasing a number of lanes to be allocated to a device of a lower mode, among the plurality of devices.

The plurality of hosts may include a first host and a second host, a mode type for the first host of a first of the plurality of devices may be a higher type, and the determining of the number of lanes may include increasing the number of lanes for the first host of the first of the plurality of devices.

The plurality of hosts may include a first host and a second host, a mode type for the second host of one of the plurality of devices may be a lower type, and the determining of the number of lanes may include decreasing the number of lanes for the second host of one of the plurality of devices.

The monitoring traffic of the plurality of devices may include monitoring traffic directed from the plurality of hosts to the plurality of devices.

The monitoring traffic of the plurality of devices may include detecting a first device and a second device having increased traffic among the plurality of devices, and the determining of the mode types of the plurality of devices according to the traffic may include determining mode types of the first device and the second device as higher modes.

The determining of the mode types of the first device and the second device as the higher modes may include determining the mode types of the first device and the second device to be the same.

The routing method may further include determining a priority of the first device and a priority of the second device, wherein the determining of the mode types of the first device and the second device as the higher modes may include determining the mode types of the first device and the second device based on the priority of the first device and the priority of the second device.

The plurality of hosts may include a first host and a second host accessing one device of the plurality of devices through a plurality of lanes, and the monitoring may include monitoring traffic for the one device of the first host and traffic for the one device of the second host.

The first host may access the one device through a first lane of the plurality of lanes, and the second host may access the one device through a second lane of the plurality of lanes; and the monitoring of the traffic for the one device of the first host and the traffic for the one device of the second host may include monitoring traffic of the first lane and traffic of the second lane.

The monitoring of the traffic of the first lane and the traffic of the second lane may include detecting an increase in traffic for the one device of the first host, the determining of the mode type may include determining a mode for the one device of the first host as a higher mode, and the performing of the routing may include additionally allocating the third lane so that the first host accesses the one device through the first lane and the third lane of the plurality of lanes.

The routing method may further include receiving an offload command from the first host; and allocating, in response to the offload command, the third lane of the plurality of lanes so that the one device accesses another device of the plurality of devices.

Some embodiments provide a system on chip, including: a monitoring module configured to monitor traffic of a plurality of devices; a mode setting module configured to determine mode types of the plurality of devices according to the traffic; and a routing module configured to perform routing according to the mode types.

The system on chip may be on a backplane, and the routing module may be configured to perform routing to allocate lanes between the plurality of devices and the backplane.

The monitoring module may be configured to monitor traffic directed from a plurality of hosts to the plurality of devices.

The plurality of devices may include at least one of a CXL SSD, a CXL DRAM, and a smart SSD.

Some embodiments provide an electronic device including: a plurality of hosts; a plurality of input/output devices that are connected to the plurality of hosts to process commands received from the plurality of hosts; and a system on chip that is configured to monitor traffic directed from the plurality of hosts to the plurality of input/output devices and configured to change a lane link connecting the plurality of hosts and the plurality of input/output devices based on the monitored traffic.

### BRIEF DESCRIPTION OF THE DRAWINGS

FIG. 1 illustrates a schematic block diagram of an electronic device according to some embodiments.

FIG. 2 illustrates a schematic block diagram of a system on chip according to some embodiments.

FIG. 3 is a drawing for explaining an operation of a system on chip according to some embodiments.

FIG. 4 is a drawing for explaining an operation of a system on chip according to some embodiments.

FIG. 5 is a drawing for explaining an operation of a system on chip according to some embodiments.

FIG. 6 is a drawing for explaining an operation of a system on chip according to some embodiments.

FIG. 7 is a drawing for explaining an operation of a system on chip according to some embodiments.

FIG. 8 is a drawing for explaining an operation of a system on chip according to some embodiments.

FIG. 9 illustrates a flowchart of a routing method according to some embodiments.

FIG. 10 illustrates a block diagram of an electronic device according to some embodiments.

FIG. 11 illustrates a chassis including electronic devices according to some embodiments.

FIG. 12 illustrates a chassis including electronic devices according to some embodiments.

FIG. 13 illustrates backplanes of an electronic device according to some embodiments.

### DETAILED DESCRIPTION OF THE EMBODIMENTS

The present disclosure will be described more fully hereinafter with reference to the accompanying drawings, in which some examples of embodiments of the disclosure are shown. As those skilled in the art would realize, the described embodiments may be modified in various different ways, all without departing from the spirit or scope of the present disclosure.

Accordingly, the drawings and description thereof provided by the present disclosure are to be regarded as illustrative in nature and not restrictive. Like reference numerals designate like elements throughout the specification. In the flowcharts described with reference to the drawings in this specification, the operation order may be changed, various operations may be merged, certain operations may be divided, and certain operations may not be performed, unless otherwise stated.

In addition, a singular form may be intended to include a plural form as well, unless the explicit expression such as “one” or “single” is used. Terms including ordinal numbers such as first, second, and the like will be used only to describe various constituent elements, and are not to be interpreted as limiting these constituent elements. These terms may be used for a purpose of distinguishing one constituent element from other constituent elements.

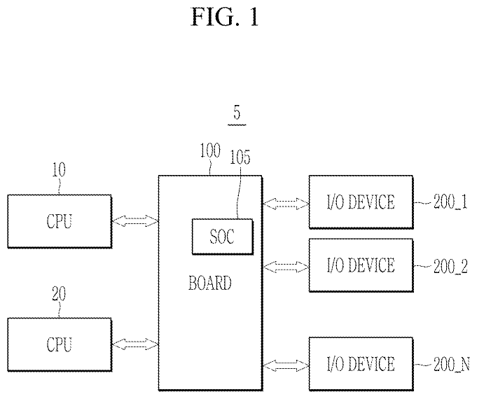

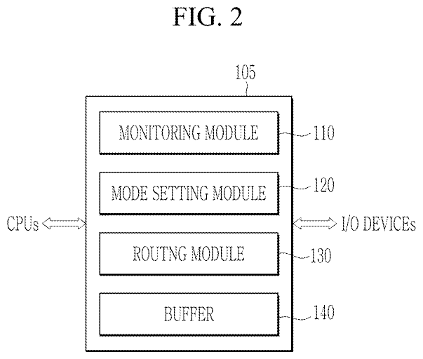

FIG. 1 illustrates a schematic block diagram of an electronic device according to some embodiments, and FIG. 2 illustrates a schematic block diagram of a system on chip according to some embodiments.

Referring to FIG. 1, an electronic device 5 according to some embodiments may include central processing units (CPUs) 10 and 20, a board 100, and a plurality of input/output (I/O) devices 200_1 to 200_N. Here, N may be an integer larger than 1.

The CPUs 10 and 20 may manage and control an overall operation of the electronic device 5. The CPUs 10 and 20 may be hosts, and the CPUs 10 and 20 may be different hosts. For example, the CPU 10 is a first host, the CPU 20 is a second host, and the CPUs 10 and 20 may individually access the plurality of I/O devices 200_1 to 200_N. Each of the CPUs 10 and 20 may transmit a command to the plurality of I/O devices 200_1 to 200_N, and may receive data according to the command from the plurality of I/O devices 200_1 to 200_N.

The CPUs 10 and 20 may be connected to the plurality of I/O devices 200_1 to 200_N through the board 100. The board 100 may include a plurality of lane links, not shown in FIG. 1 or 2. For example, the board 100 may include first lanes connected to the CPU 10, second lanes connected to the CPU 20, and third lanes connected to the plurality of I/O devices 200_1 to 200_N. Here, the number of the first lanes and the number of the second lanes may be the same, but the present disclosure is not necessarily limited thereto, and in some embodiments the number of the first lanes and the number of the second lanes may be different. The number of the third lanes may be greater than or equal to a sum of the number of the first lanes and the number of the second lanes.

The CPUs 10 and 20 may individually access each of the plurality of I/O devices 200_1 to 200_N. For example, the CPU 10 may access the first I/O device 200_1 and the CPU 20 may access the second I/O device 200_2. In addition, the CPUs 10 and 20 may simultaneously access each of the plurality of I/O devices 200_1 to 200_N. For example, the CPUs 10 and 20 may simultaneously access the first I/O device 200_1 and perform an operation. When the first I/O device 200_1 includes a plurality of modules, the CPUs 10 and 20 may access the same module (e.g., a first module of the plurality of modules of the I/O device 200_1) to perform operations, and/or the CPUs 10 and 20 may access different modules (e.g., the first module and a second module of the plurality of modules of the I/O device 200_1) to perform operations. In some embodiments, the accessed same module (e.g., the first module) may provide the same functionality to both the first and second CPUs 10 and 20, and different modules may provide different functionality.

Among the plurality of I/O devices 200_1 to 200_N, the number of lanes required by each I/O device may be different. The board 100 may be connected to the plurality of I/O devices 200_1 to 200_N according to the number of lanes required by each I/O device. In some embodiments, when the electronic device 5 is implemented as a server, the CPUs 10 and 20 may be provided or arranged on a baseboard and may operate according to commands of a tenant, and the board 100 may be implemented as a backplane and may provide a connection with the plurality of I/O devices 200_1 to 200_N.

The plurality of I/O devices 200_1 to 200_N may be heterogeneous devices. Each of the plurality of I/O devices 200_1 to 200_N may be implemented as accelerators, memory devices, storage devices, network cards, or the like. For example, where the I/O device 200_1 is implemented as an accelerator, the accelerator may be implemented as a graphics processing unit (GPU), a neural processing unit (NPU), a tensor processing unit (TPU) providing computational functions, or so on. Where the I/O device 200_1 is implemented as a memory device, the memory device may be a dynamic random access memory (DRAM), and may include a compute express link (CXL) DRAM operating based on a peripheral component interconnect express (PCIe) interface. Where the I/O device 200_1 is implemented as a storage device, the storage device may include a hard disk drive (HDD) device or a solid state drive (SSD) device. For example, the SSD device may be implemented as a non-volatile memory express (NVMe) SSD, a CXL SSD, a CXL computational SSD (also referred to as a smart SSD), or the like. Where the I/O device 200_1 is implemented as a network card, the network card may be implemented as a network interface card (NIC) and may provide a web search function.

The board 100 may include a system on chip (SOC) 105. The SOC 105 may perform adaptive routing by using third lanes between the board 100 and the plurality of I/O devices 200_1 to 200_N. For example, the SOC 105 may adjust (e.g., may adjust adaptively) the number of lanes assigned to (or connected to) the plurality of I/O devices 200_1 to 200_N according to traffic of the plurality of I/O devices 200_1 to 200_N. Specifically, the SOC 105 may detect traffic of the plurality of I/O devices 200_1 to 200_N, and may determine or set modes of the plurality of I/O devices 200_1 to 200_N according to the traffic. The modes of the plurality of I/O devices 200_1 to 200_N may be determined or set for or on behalf of the CPUs 10 and 20. The SOC 105 may determine a mode corresponding to a connection between the CPUs 10 and 20 and the plurality of I/O devices 200_1 to 200_N. There may be a plurality of mode types. For example, the plurality of mode types may include a first mode, a second mode, and an M-th mode, wherein M may be an integer greater than or equal to 2. The SOC 105 may determine at least one of a link speed and a link width of the plurality of I/O devices 200_1 to 200_N according to the mode type. That is, the plurality of I/O devices 200_1 to 200_N may operate based on the determined link speed and link width. The SOC 105 may branch lanes according to modes of a plurality of I/O devices 200_1 to 200_N. The SOC 105 may branch at least one lane corresponding to each mode corresponding to the connection between CPUs 10 and 20 and the plurality of I/O devices 200_1 to 200_N among the third lanes, and may assign it to the plurality of I/O devices 200_1 to 200_N.

Referring to FIG. 2, the SOC 105 may include a monitoring module 110, a mode setting module 120, a routing module 130, and a buffer 140.

The monitoring module 110 may monitor traffic of the plurality of I/O devices 200_1 to 200_N. The plurality of I/O devices 200_1 to 200_N may receive data from the CPUs 10 and 20, and the plurality of I/O devices 200_1 to 200_N may exchange data with each other.

The monitoring module 110 may monitor traffic through the first lanes corresponding to the CPU 10, the second lanes corresponding to the CPU 20, and the third lanes corresponding to the plurality of I/O devices 200_1 to 200_N. The traffic may be an amount of workload passing through each lane during a predetermined period of time, and the traffic of the first lanes and the traffic of the second lanes may be different. The monitoring module 110 may generate traffic information corresponding to the plurality of I/O devices 200_1 to 200_N by monitoring commands and data passing through each lane. For example, the monitoring module 110 may generate the traffic information by increasing the traffic of the I/O device 200_1 when an amount of data outputted from the I/O device 200_1 increases. When transmission of a command accessing data stored in the I/O device 200_1 increases, the monitoring module 110 may determine that the traffic of the I/O device 200_1 will increase, and may generate traffic information by increasing the traffic of the I/O device 200_1 in advance. The monitoring module 110 may transmit traffic information to the mode setting module 120.

In addition, the monitoring module 110 may specify the type of the plurality of I/O devices 200_1 to 200_N. For example, the monitoring module 110 may specify a type by using a connection state, connection information, transmitted data, and/or the like. The connection state may include mode information of the plurality of I/O devices 200_1 to 200_N. The connection information may include identifiers of the plurality of I/O devices 200_1 to 200_N. The transmitted data may include commands inputted to the plurality of I/O devices 200_1 to 200_N. The plurality of I/O devices 200_1 to 200_N may receive different types of commands according to device types. The monitoring module 110 may transmit type information to the mode setting module 120.

Each of the plurality of I/O devices 200_1 to 200_N may operate in a mode predetermined by the CPUs 10 and 20 or the mode setting module 120. The plurality of I/O devices 200_1 to 200_N may have a default mode determined according to the device type. The mode setting module 120 may change or set the mode of the plurality of I/O devices 200_1 to 200_N according to traffic information. For example, the mode setting module 120 may change the mode of the I/O device having relatively high traffic to a higher mode. The mode setting module 120 may change the mode of the I/O device having relatively low traffic to a lower mode. The upper mode may have a relatively large number of lanes, and the lower mode may have a relatively small number of lanes.

In some embodiments, the mode setting module 120 may determine the mode as shown in Table 1 according to traffic information.

TABLE 1

| MODE TYPE | LINK SPEED | LINK WIDTH |
|---|---|---|
| FIRST MODE | 32 GT/s | x16 |
| SECOND MODE | 32 GT/s | x8, x4 |

Referring to Table 1, the first mode may allocate 16 lanes as a link width and may support a link speed of 32 GT/s. The second mode may allocate 8 lanes and 4 lanes as link widths and may support a link speed of 32 GT/s.

The mode setting module 120 may determine or set a mode type of an I/O device having a relatively high traffic as the first mode. For example, the mode setting module 120 may determine or set a mode of an I/O device generating the highest traffic among the plurality of I/O devices 200_1 to 200_N as the first mode. The mode setting module 120 may determine or set a mode type of an I/O device having a relatively low traffic as the second mode. For example, the mode setting module 120 may determine or set a mode of an I/O device generating the lowest traffic among the plurality of I/O devices 200_1 to 200_N as the second mode.

The mode setting module 120 may use the device type to determine or set the mode. For example, the plurality of I/O devices 200_1 to 200_N may have different required minimum number of lanes according to the device types. The mode setting module 120 may determine or set the mode of the plurality of I/O devices 200_1 to 200_N based on the minimum number of lanes. For example, an I/O device requiring at least 16 lanes may not operate in the second mode. Accordingly, the mode setting module 120 may determine or set the mode type as the first mode rather than the second mode, even when the I/O device generates the lowest traffic.

Among the plurality of I/O devices 200_1 to 200_N, the number of lanes (e.g., a total number of lanes) used by the I/O device(s) in the first mode may be the same as the number of lanes (e.g., a total number of lanes) used by the I/O device(s) in the second mode. For example, the mode setting module 120 may determine the first I/O device 200_1 among the plurality of I/O devices 200_1 to 200_N in the first mode and may allocate 16 lanes thereto, and may determine the second and third I/O devices 200_2 and 200_3 among the plurality of I/O devices 200_1 to 200_N in the second mode and may allocate 8 lanes respectively thereto. That is, the first I/O device 200_1 in first mode and the second and third I/O devices 200_2 and 200_3 in second mode may use 16 lanes to operate at 32 GT/s.

In some embodiments, the mode setting module 120 may determine or set the first I/O device 200_1 of the plurality of I/O devices 200_1 to 200_N in the first mode and may allocate 16 lanes thereto, may determine or set the second I/O device 200_2 thereof in the second mode and may allocate 8 lanes thereto, and may determine or set the third and fourth I/O devices 200_3 and 200_4 thereof in the second mode and may allocate 4 lanes respectively thereto. That is, the first I/O device 200_1 in first mode may use 16 lanes to operate at 32 GT/s, and the second to fourth I/O devices 200_2 to 200_4 in the second mode may combine to use 16 lanes to operate at 32 GT/s. As described above, the mode setting module 120 may perform adaptive routing in various combinations according to the number of lanes supported in each mode.

In some embodiments, the mode setting module 120 may determine the mode as shown in Table 2 according to traffic information.

TABLE 2

| MODE TYPE | LINK SPEED | LINK WIDTH |
|---|---|---|
| FIRST MODE | 32 GT/s | x16 |
| SECOND MODE | 32 GT/s | x8, x4 |
| THIRD MODE | 32 GT/s | x2, x1 |

Referring to Table 2, the first mode may allocate 16 lanes as a link width and may support a link speed of 32 GT/s. The second mode may allocate 8 lanes and 4 lanes as link widths, and it may support a link speed of 32 GT/s. The third mode may allocate 2 lanes and 1 lane as link widths, and it may support a link speed of 32 GT/s.

The mode setting module 120 may determine a mode type of an I/O device having a relatively high traffic as the first mode. For example, the mode setting module 120 may determine or set a mode of an I/O device generating the highest traffic among the plurality of I/O devices 200_1 to 200_N as the first mode. The mode setting module 120 may determine or set a mode type of an I/O device having a relatively low traffic as the second or third mode. For example, the mode setting module 120 may determine or set a mode of an I/O device generating the lowest traffic among the plurality of I/O devices 200_1 to 200_N as the third mode.

The mode setting module 120 may use the device type to determine or set the mode. For example, the plurality of I/O devices 200_1 to 200_N may have different required minimum number of lanes according to the device types. The mode setting module 120 may determine or set the mode of the plurality of I/O devices 200_1 to 200_N based on the minimum number of lanes. For example, an I/O device requiring at least 4 lanes may not operate in the third mode. Accordingly, the mode setting module 120 may determine the mode type as the second mode rather than the third mode, even when the I/O device generates the lowest traffic.

Among the plurality of I/O devices 200_1 to 200_N, the number of lanes (e.g., a total number of lanes) used by the I/O device(s) in the first mode, the number of lanes (e.g., a total number of lanes) used by the I/O device(s) in the second mode, and the number of lanes (e.g., a total number of lanes) used by the I/O device(s) in the third mode may be the same. For example, the mode setting module 120 may determine or set the first I/O device 200_1 of the plurality of I/O devices 200_1 to 200_N in the first mode and may allocate 16 lanes to the first I/O device 200_1, may determine or set the second and third I/O devices 200_2 and 200_3 thereof in the second mode and may allocate 8 lanes respectively to each of the second and third I/O devices 200_2 and 200_3, and may determine or set the fourth to eleventh I/O devices 200_4 to 200_11 thereof in the third mode to allocate 2 lanes respectively to each of the fourth to eleventh I/O devices 200_4 to 200_11. That is, the first I/O device 200_1 in the first mode may use 16 lanes to operate at 32 GT/s, the second and third I/O devices 200_2 and 200_3 in the second mode combined may use 16 lanes to operate at 32 GT/s, and the fourth to eleventh I/O devices 200_4 to 200_11 in third mode combined may use 16 lanes to operate at 32 GT/s.

In some embodiments, the mode setting module 120 may determine or set the first I/O device 200_1 of the plurality of I/O devices 200_1 to 200_N in the first mode and may allocate 16 lanes to the first I/O device 200_1, may determine or set the second I/O device 200_2 thereof in the second mode to allocate 8 lanes to the second I/O device 200_2, may determine or set the third and fourth I/O devices 200_3 and 200_4 thereof in the second mode and allocate 4 lanes respectively to each of the third and fourth I/O devices 200_3 and 200_4, may determine or set the fifth to tenth I/O devices 200_5 to 200_10 thereof in the third mode and allocate 2 lanes respectively to each of the fifth to tenth I/O devices 200_5 to 200_10, and may determine or set the 11th to 14th I/O devices 200_11 to 200_14 thereof in the third mode and may allocate one lane respectively to each of the 11th to 14th I/O devices 200_11 to 200_14. That is, the first I/O device 200_1 in the first mode may use 16 lanes to operate at 32 GT/s, the second to fourth I/O devices 200_2 to 200_4 in the second mode may combined use 16 lanes to operate at 32 GT/s, and the fifth to fourteenth I/O devices 200_4 to 200_14 in third mode may combined use 16 lanes to operate at 32 GT/s. As described above, the mode setting module 120 may perform adaptive routing in various combinations according to the number of lanes supported in each mode.

In some embodiments, the mode setting module 120 may determine the mode as shown in Table 3 according to traffic information.

TABLE 3

| MODE TYPE | LINK SPEED | LINK WIDTH |
|---|---|---|
| FIRST MODE | 32 GT/s | x16 |
| SECOND MODE | 32 GT/s | x8, x4 |
| THIRD MODE | 32 GT/s | x2, x1 |
| | 16 GT/s | x16, x8, x4, x2, x1 |
| | 8 GT/s | x16, x8, x4, x2, x1 |

Referring to Table 3, the first mode may allocate 16 lanes as a link width and may support a link speed of 32 GT/s. The second mode may allocate 8 lanes and 4 lanes as link widths, and may support a link speed of 32 GT/s. The third mode may support three link speeds of 32 GT/s, 16 GT/s, and 8 GT/s. For example, the third mode may allocate 2 lanes and 1 lane as link widths and support a link speed of 32 GT/s, may allocate 16 lanes, 8 lanes, 4 lanes, 2 lanes, and 1 lane as link widths and support a link speed of 16 GT/s, or may allocate 16 lanes, 8 lanes, 4 lanes, 2 lanes, and 1 lane as link widths and support a link speed of 8 GT/s.

The mode setting module 120 may determine or set a mode type of an I/O device having a relatively high traffic as the first mode. For example, the mode setting module 120 may determine or set a mode of an I/O device generating the highest traffic among the plurality of I/O devices 200_1 to 200_N as the first mode. The mode setting module 120 may determine or set a mode type of an I/O device having a relatively low traffic as the second or third mode. For example, the mode setting module 120 may determine or set a mode of an I/O device generating the lowest traffic among the plurality of I/O devices 200_1 to 200_N as the third mode.

The mode setting module 120 may use the device type to determine or set the mode. For example, the plurality of I/O devices 200_1 to 200_N may have different required minimum number of lanes according to the device types. The mode setting module 120 may determine the mode of the plurality of I/O devices 200_1 to 200_N based on the minimum number of lanes. For example, an I/O device that requires at least 4 lanes may not be able to operate at a link speed of 32 GT/s in the third mode. Accordingly, even when the I/O device generates the lowest traffic, the mode setting module 120 may determine the mode type for the I/O device as the second mode, or may determine the link speed as 16 GT/s or 8 GT/s of the third mode. As described above, the mode setting module 120 may perform adaptive routing in various combinations according to the number of lanes and the link speed supported in each mode.

In some embodiments, the mode setting module 120 may perform routing according to the mode type and the device type. For example, in the case of I/O devices that may communicate with each other without the CPUs 10 and 20, the mode setting module 120 may perform routing so that the I/O devices may communicate with each other. In this case, the mode predetermined module 120 may perform routing based on the mode type of the I/O devices. In addition, the mode setting module 120 may perform routing in consideration of the minimum or maximum number of lanes determined according to the device type.

In the present disclosure, it has been described that the mode setting module 120 may determine the mode for the CPUs 10 and 20 of the plurality of I/O devices 200_1 to 200_N with reference to Table 1 to Table 3, but the present disclosure is not necessarily limited thereto, and the mode setting module 120 may determine various modes by combining the link speed and the link width.

The mode setting module 120 may initialize the modes of the plurality of I/O devices 200_1 to 200_N upon receiving a recovery command from the CPUs 10 and 20. For example, the mode setting module 120 may set the plurality of I/O devices 200_1 to 200_N to have a default mode.

In addition, the mode setting module 120 may set priorities of the plurality of I/O devices 200_1 to 200_N. For example, the mode setting module 120 may receive commands for the priorities from the CPUs 10 and 20. The mode setting module 120 may set the priorities of the plurality of I/O devices 200_1 to 200_N according to the commands. The mode setting module 120 may determine the modes of the plurality of I/O devices 200_1 to 200_N according to the priorities.

For example, at least two of the plurality of I/O devices 200_1 to 200_N have high traffic, and thus contention may occur therebetween. The monitoring module 110 may notify the mode setting module 120 that at least two I/O devices have high traffic as a result of monitoring. Accordingly, the mode setting module 120 may allocate an upper mode to an I/O device having a higher priority and may allocate a lower mode to an I/O device having a lower priority, among the at least two I/O devices having the high traffic. Here, the lower mode allocated to the I/O device having the lower priority may be a higher mode than that of other low-traffic I/O devices.

In some embodiments, when contention occurs, the mode setting module 120 may evenly distribute lanes to the I/O devices in which the contention has occurred. That is, the mode setting module 120 may equally set the modes of the I/O devices in which the contention has occurred. In this case, the mode setting module 120 may allocate fewer lanes by changing other I/O devices in which contention does not occur to lower modes. Here, the lower mode may be a mode lower than a mode set for the I/O devices in which the contention has occurred.

The mode setting module 120 may change lane links according to the determined mode. In some embodiments, the mode setting module 120 may transmit a lane change request to the CPUs 10 and 20 and the plurality of I/O devices 200_1 to 200_N. The mode setting module 120 may transmit a lane change command to the routing module 130 when receiving a response signal to the lane change request from the CPUs 10 and 20 and the plurality of I/O devices 200_1 to 200_N.

In some embodiments, the mode setting module 120 may transmit a lane change notification to the CPUs 10 and 20 and the plurality of I/O devices 200_1 to 200_N. The mode setting module 120 may transmit a lane change command to the routing module 130. That is, the mode setting module 120 may transmit the lane change command regardless of response signals from the CPUs 10 and 20 and the plurality of I/O devices 200_1 to 200_N.

The routing module 130 may perform routing in response to the lane change command of the mode setting module 120. The routing may be performed between the CPUs 10 and 20 and the plurality of I/O devices 200_1 to 200_N, or between the plurality of I/O devices 200_1 to 200_N. For example, the routing module 130 may branch the third lanes so that the CPUs 10 and 20 and the plurality of I/O devices 200_1 to 200_N may be connected to each other according to the lane change command. In addition, the routing module 130 may branch the third lanes so that the plurality of I/O devices 200_1 to 200_N may be connected to each other.

The routing module 130 may include switches for performing routing. The switches may include a first switch arranged between the first lanes and the third lanes, a second switch arranged between the second lanes and the third lanes, and a third switch arranged between the third lanes. The routing module 130 may perform routing by controlling at least one of the first switch, the second switch, and the third switch.

The buffer 140 may store data while the routing module 130 changes lanes. For example, routing module 130 may take some time to change the lanes. In this case, the buffer 140 may store data directed to the I/O device corresponding to the lane to be changed. The buffer 140 may temporarily store data. The buffer 140 may be implemented as a volatile memory or a non-volatile memory.

In FIG. 1, the electronic device 5 is illustrated as including two CPUs 10 and 20, but the present disclosure is not necessarily limited thereto, and the electronic device 5 may include three or more CPUs. In this case, the SOC 105 may adaptively perform routing between three or more CPUs and the plurality of I/O devices 200_1 to 200_N.

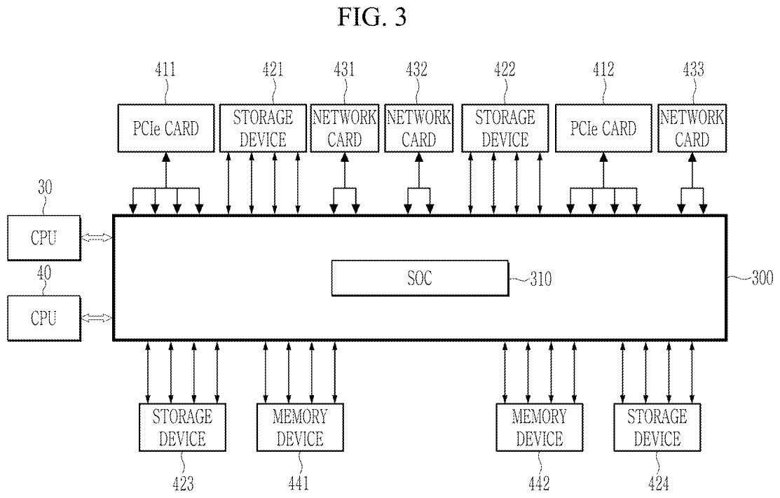

FIG. 3 to FIG. 5 are drawings for explaining an operation of a system on chip according to some embodiments.

Referring to FIG. 3, CPUs 30 and 40 may be connected to a plurality of I/O devices 411˜442 through a backplane 300. Here, the plurality of I/O devices 411˜442 may include PCIe cards 411 and 412, storage devices 421, 422, 423, and 424, network cards 431, 432, and 433, and memory devices 441 and 442. The plurality of I/O devices 411˜442 may communicate with the CPUs 30 and 40, and the plurality of I/O devices 411˜442 may communicate with each other. In FIG. 3, one arrow coming out of the backplane 300 may mean 4 lanes, but the figure and the not necessarily limited thereto, and may be implemented with various numbers of lanes.

The PCIe cards 411 and 412 may each be connected to at least one PCIe device (not shown) so that the CPUs 30 and 40 may access the at least one PCIe device. The PCIe cards 411 and 412 may be connected to the backplane 300 through 16 lanes to perform communication.

The storage devices 421, 422, 423, and 424 may be NVMe SSDs, CXL SSDs, CXL computational SSDs (or smart SSDs), or the like. The storage devices 421, 422, 423, and 424 may be connected to the backplane 300 through 16 lanes to perform communication. In some embodiments, the storage devices 421, 422, 423, and 424 may be different. For example, the storage devices 421 and 422 may be NVMe SSDs, and the storage devices 423 and 424 may be CXL SSDs.

The network cards 431, 432, and 433 may be network interface cards. The network cards 431, 432, and 433 may communicate with the backplane 300 through 8 lanes.

The memory devices 441 and 442 may be CXL DRAM. The memory devices 441 and 442 may be connected to the backplane 300 through 16 lanes to perform communication. In some embodiments, the PCIe cards 411 and 412, the storage devices 421 and 422, and the network cards 431, 432, and 433 may be provided on the front side of the electronic device, and the storage devices 423 and 424 and the memory devices 441 and 442 may be provided on the rear side of the electronic device.

The backplane 300 may include an SOC 310. For example, the SOC 310 may be arranged or provided in the backplane 300. The SOC 310 may monitor traffic of the plurality of I/O devices 411˜442, and may determine modes of the plurality of I/O devices 411˜442 according to the traffic (e.g., modes set for or on behalf of the CPUs 30 and 40). There may be a plurality of mode types. For example, the plurality of mode types may include a first mode, a second mode, and an M-th mode, where M may be an integer greater than or equal to 2. The SOC 310 may determine the link speed and link width of the plurality of I/O devices according to the mode type. That is, the plurality of I/O devices 411˜442 may operate based on the determined link speed and link width. The SOC 310 may branch lanes according to modes of a plurality of I/O devices. The SOC 310 may branch at least one of the third lanes. The SOC 310 may include a plurality of modules for performing this operation.

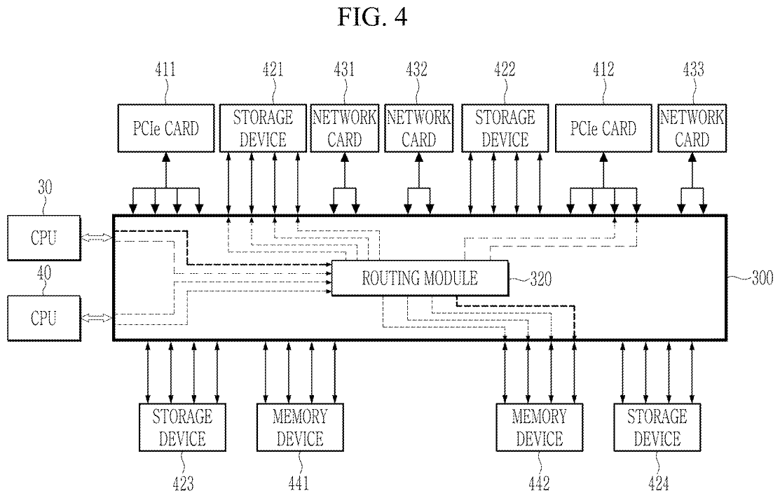

Referring to FIG. 4, the SOC 310 may include a routing module 320 for changing lanes connected to the plurality of I/O devices. The routing module 320 may be connected to the CPU 30 through the first lanes, connected to the CPU 40 through the second lanes, and connected to the plurality of I/O devices 411˜442 through the third lanes. In some embodiments, the routing module 320 may provide a path through which the CPU 30 communicates with the PCIe card 412 and the memory device 442. For example, the routing module 320 may allocate 8 lanes to the PCIe card 412 and 4 lanes to the memory device 442. In addition, the routing module 320 may provide a path through which the CPU 40 communicates with the storage device 421 and the memory device 442. For example, the routing module 320 may allocate 16 lanes to the storage device 421 and 12 lanes to the memory device 442. That is, the CPUs 30 and 40 may individually access the I/O device (for example, the PCIe card 412 and the storage device 421), or may simultaneously access the I/O device (for example, the memory device 442). In other words, the plurality of I/O devices 411˜442 may be used by the CPUs 30 and 40.

The routing module 320 may perform adaptive routing based on traffic for the plurality of I/O devices 411˜442. The traffic may include a workload directed from the CPU 30 to the plurality of I/O devices 411˜442, a workload directed from the CPU 40 to the plurality of I/O devices 411˜442, and a workload exchanged between the plurality of I/O devices 411˜442. For example, the routing module 320 may additionally allocate lanes to I/O devices with increased traffic, and may reduce and allocate lanes to I/O devices with reduced traffic.

The routing module 320 may change the number of lanes of the plurality of I/O devices 411˜442 based on a mode determined according to a monitoring result. For example, the SOC 310 may include a monitoring module for monitoring traffic. The monitoring module may determine the mode of the plurality of I/O devices according to the traffic to notify the routing module 320 of the determined mode. The monitoring module may monitor traffic from the CPU 30 to the plurality of I/O devices 411˜442, traffic from the CPU 40 to the plurality of I/O device 411˜442 s, and traffic between the plurality of I/O devices 411˜442. The routing module 320 may perform adaptive routing by receiving information about the mode from the monitoring module.

FIG. 4 shows a configuration in which the routing module 320 provides access paths to the PCIe card 412, the storage device 421, and the memory device 442, but the present disclosure is not limited thereto, and the routing module 320 may use a combination of various numbers of lanes to provide a path to access a plurality of I/O devices such as the PCIe card 411, the storage devices 422, 423, and 424, the network cards 431, 432, and 433, and the memory device 441.

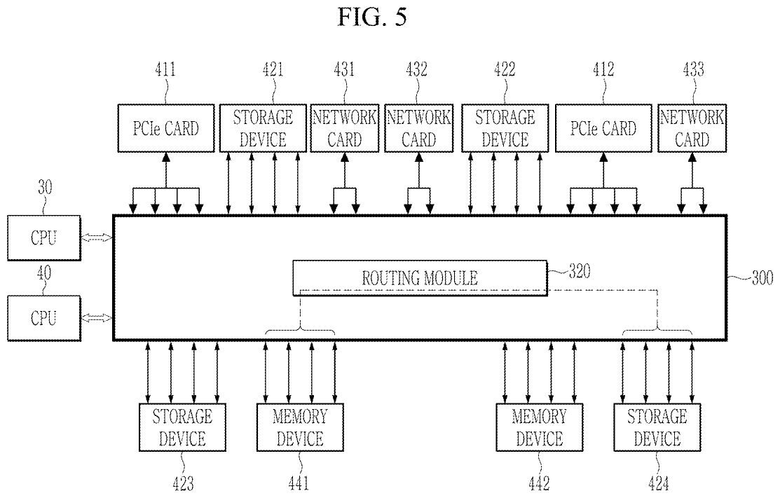

Referring to FIG. 5, the routing module 320 may provide a path through which a plurality of I/O devices (for example, the storage device 424 and the memory device 441) communicate with each other. That is, the storage device 424 and the memory device 441 may communicate with each other through the routing module 320. For example, the storage device 424 and the memory device 441 may use the CXL protocol.

The routing module 320 may change the number of lanes of the plurality of I/O devices based on a mode determined according to a monitoring result. For example, the routing module 320 may change the number of lanes allocated to the storage device 424 based on the mode. Similarly, the routing module 320 may change the number of lanes allocated to the memory device 441 based on the mode.

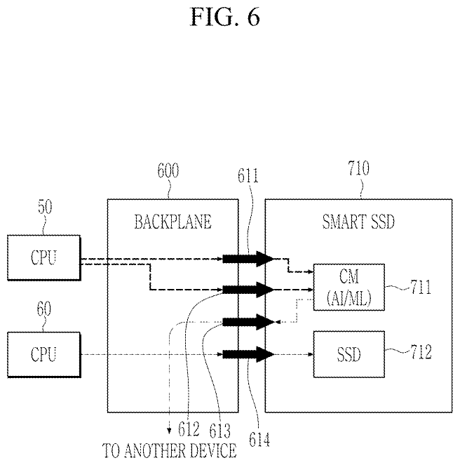

FIG. 6 is a drawing for explaining an operation of a system on chip according to some embodiments.

Referring to FIG. 6, an electronic device according to some embodiments may use the CXL protocol. The electronic device according to some embodiments may include CPUs 50 and 60, a backplane 600, and a smart SSD 710. The backplane 600 may include an SOC (not shown), and the description of the SOC 105 described with reference to FIG. 1 and FIG. 2 may be equally applied to the SOC of the backplane 600. The smart SSD 710 may include a computing module (CM) 711 and an SSD 712. The computing module 711 may provide artificial intelligence (AI) or machine learning (ML) functions. The SSD 712 may store data and output the stored data in response to a read command.

The backplane 600 may be connected to the smart SSD 710 through lanes 611, 612, 613, and 614. The CPUs 50 and 60 may access (e.g., may access simultaneously) the smart SSD 710 through the backplane 600. For example, the CPU 50 may access the smart SSD 710 through the lane 611, and the CPU 60 may access the smart SSD 710 through the lane 614.

The SOC of the backplane 600 may monitor traffic of the smart SSD 710. When the traffic of the smart SSD 710 increases, the SOC may change the mode of the CPU 50 and/or the smart SSD 710 that caused the traffic increase. The SOC may additionally allocate lanes according to the changed mode. For example, the SOC may detect that the traffic of the smart SSD 710 has increased due to the CPU 50. Accordingly, the SOC may additionally allocate the lane 612. That is, the CPU 50 may access the smart SSD 710 through the lanes 611 and 612.

The SOC may perform routing based on the number of lanes allocated to the CPUs 50 and 60. For example, when the CPUs 50 and 60 are using all of the lanes 611, 612, 613, and 614, the SOC may decrease the number of lanes of the CPU 50 with relatively low traffic, and may increase the number of lanes of the CPU 60 with relatively high traffic.

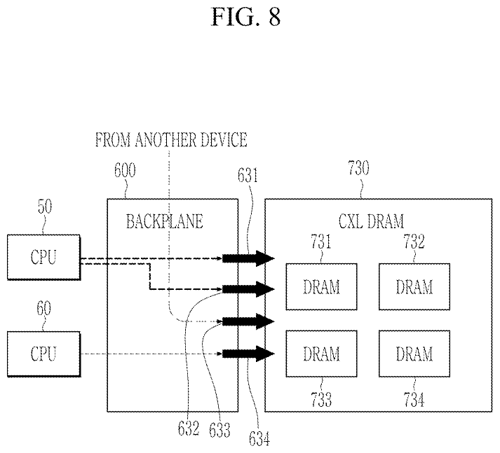

The CPUs 50 and 60 may transmit an offload command. The offload command may refer to a command to transmit a computing result to another I/O device without transmitting the computing result to the CPUs 50 and 60. For example, the CPU 50 may transmit the offload command to the smart SSD 710. The smart SSD 710 receiving the offload command may communicate with another I/O device without passing through the CPUs 50 and 60. The SOC may allocate lane 613 in response to the offload command. The smart SSD 710 may use the lane 613 to communicate with another I/O device. For example, the other I/O device may be a CXL DRAM 730 shown in FIG. 8. As described above, since the SOC adaptively performs routing, and the computational efficiency of the CPUs 50 and 60 may be increased.

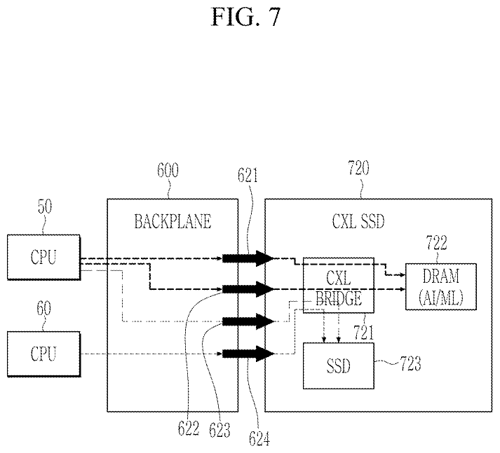

FIG. 7 is a drawing for explaining an operation of a system on chip according to some embodiments.

Referring to FIG. 7, an electronic device according to some embodiments may use the CXL protocol. The electronic device according to some embodiments may include the CPUs 50 and 60, the backplane 600, and a CXL SSD 720. The backplane 600 may include an SOC (not shown), and the description of the SOC 105 described with reference to FIG. 1 and FIG. 2 may be equally applied to this SOC. The CXL SSD 720 may include a CXL bridge 721, a DRAM 722, and an SSD 723. The CXL bridge 721 may support access to the DRAM 722 or the SSD 723 according to the commands of the CPUs 50 and 60. The DRAM 722 may support the operation of the CPUs 50 and 60 while temporarily storing data. The SSD 723 may store data and may output the stored data in response to a read command.

The backplane 600 may be connected to the CXL SSD 720 through lanes 621, 622, 623, and 624. The CPUs 50 and 60 may access (e.g., may simultaneously access) the CXL SSD 720 through the backplane 600. For example, the CPU 50 may access the CXL SSD 720 through the lane 621, and the CPU 60 may access the CXL SSD 720 through the lane 624.

The SOC of the backplane 600 may monitor traffic of the CXL SSD 720. When the traffic of the CXL SSD 720 increases, the SOC may change the mode of a host and/or the CXL SSD 720 that caused the traffic increase. The SOC may additionally allocate lanes according to the changed mode. For example, the SOC may detect that the traffic of the CXL SSD 720 has increased due to the CPU 50. The CPU 50 may request access to the DRAM 722 and the SSD 723 of the CXL SSD 720. Accordingly, the SOC may additionally allocate the lanes 622 and 623. That is, the CPU 50 may access the CXL SSD 720 through the lanes 621, 622 and 623. The CXL bridge 721 may transmit workloads through the lanes 621, 622, and 623 to the DRAM 722 and the SSD 723. Accordingly, the CPU 50 may access the DRAM 722 through the lanes 621 and 622, and may access the SSD 723 through the lane 623.

The SOC may perform routing based on the number of lanes allocated to the CPUs 50 and 60. For example, when the CPUs 50 and 60 are using all of the lanes 621, 622, 623, and 624, the SOC may decrease the number of lanes of the CPU 50 with relatively low traffic, and may increase the number of lanes of the CPU 60 with relatively high traffic. As described above, since the SOC adaptively performs routing, the computational efficiency of the CPUs 50 and 60 may be increased.

FIG. 8 is a drawing for explaining an operation of a system on chip according to some embodiments.

Referring to FIG. 8, an electronic device according to some embodiments may use the CXL protocol. The electronic device according to the embodiment may include the CPUs 50 and 60, the backplane 600, and the CXL DRAM 730. The backplane 600 may include an SOC (not shown), and the description of the SOC 105 described with reference to FIG. 1 and FIG. 2 may be equally applied to this SOC. The CXL DRAM 730 may include a plurality of DRAMs 731, 732, 733, and 734. The plurality of DRAMs 731, 732, 733, and 734 may support operations of the CPUs 50 and 60 while temporarily storing data.

The backplane 600 may be connected to the CXL DRAM 730 through lanes 631, 632, 633, and 634. The CPUs 50 and 60 may simultaneously access the CXL DRAM 730 through the backplane 600. For example, the CPU 50 may access the CXL DRAM 730 through the lane 631, and the CPU 60 may access the CXL DRAM 730 through the lane 634.

The SOC of the backplane 600 may monitor traffic of the CXL DRAM 730. When the traffic of the CXL DRAM 730 increases, the SOC may change the mode of a host and/or the CXL DRAM 730 that caused the traffic increase. The SOC may additionally allocate lanes according to the changed mode. For example, the SOC may detect that the traffic of the CXL DRAM 730 has increased due to the CPU 50. Accordingly, the SOC may additionally allocate the lane 632. That is, the CPU 50 may access the CXL DRAM 730 through the lanes 631 and 632.

The SOC may perform routing based on the number of lanes allocated to the CPUs 50 and 60. For example, when the CPUs 50 and 60 are using all of the lanes 631, 632, 633, and 634, the SOC may decrease the number of lanes of the CPU 60 with relatively low traffic, and may increase the number of lanes of the CPU 60 with relatively high traffic.

The SOC may allocate the lane 633 in response to an offload command from the CPUs 50 and 60. The CXL DRAM 730 may use the lane 633 to communicate with another I/O device. For example, another I/O device may be the smart SSD 710 shown in FIG. 6. As described above, since the SOC adaptively performs routing, the computational efficiency of the CPUs 50 and 60 may be increased.

FIG. 6 to FIG. 8 show that the backplane 600 is connected to the smart SSD 710, the CXL SSD 720, and the CXL DRAM 730, respectively, but in some embodiments the backplane 600 may be connected to a combination or all of the smart SSD 710, the CXL SSD 720, and the CXL DRAM 730.

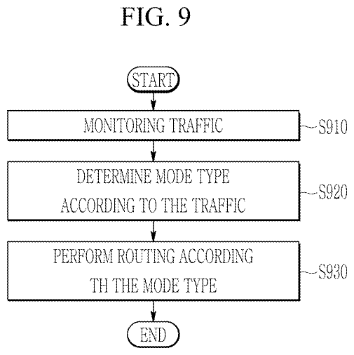

FIG. 9 illustrates a flowchart of a routing method according to some embodiments.

A routing method according to some embodiments may be performed by a system on chip (SOC) of a backplane connected between a plurality of hosts and a plurality of devices. The plurality of devices may include a storage device, a memory device, a network card, an accelerator, and/or the like. For example, the plurality of devices may include at least one of a CXL SSD, a CXL DRAM, and a smart SSD. The routing method may be a routing method performed in a server.

The SOC may monitor traffic of the plurality of devices (operation S910). The traffic may refer to traffic directed from a plurality of hosts to a plurality of devices. The SOC may detect a device with increased or decreased traffic among the plurality of devices. The number of devices detected by the SOC may be plural.

The plurality of hosts may include a first host and a second host. For example, the first host and the second host may access one of the plurality of devices through a plurality of lanes. The SOC may monitor traffic for one device in the first host and traffic for one device in the second host.

For example, the first host may access one device through a first lane of a plurality of lanes, and the second host may access one device (which may the same device) through a second lane of the plurality of lanes. The SOC may monitor the traffic of the first lane and the traffic of the second lane. The SOC may detect an increase in traffic between one device and the first host.

The SOC may determine mode types of the plurality of devices according to the traffic (operation S920). The SOC may determine and/or set a mode type of one of the plurality of devices for the plurality of hosts according to the traffic. The plurality of hosts may include a first host and a second host. For example, the SOC may determine the mode type of one device for the first host and the mode type of one device for the second host.

There may be a plurality of mode types. In some embodiments, the mode types may include a first mode and a second mode. The SOC may be determined or set as the first mode or the second mode according to traffic. Here, at least one of the link speed and the link width supported by the first mode may be greater than or equal to at least one of the link speed and the link width supported by the second mode.

In some embodiments, the mode types may include a first mode, a second mode, and a third mode. The SOC may be determined or set as one of the first mode, the second mode, and the third mode according to traffic. Here, at least one of the link speed and the link width supported by the first mode may be greater than or equal to at least one of the link speed and the link width supported by the second mode, and at least one of the link speed and the link width supported by the second mode may be greater than or equal to at least one of the link speed and the link width supported by the third mode.

When the SOC detects an increase in traffic for one device of the first host, the SOC may determine the mode of one device of the first host as a higher mode.

In operation S920, when there are a plurality of devices (for example, a first device and a second device) for which the SOC has detected a traffic change, the SOC may determine the mode type of the first device and the mode type of the second device as higher modes. In some embodiments, the SOC may equally determine the mode type of the first device and the mode type of the second device. In some embodiments, the SOC may determine the mode type by considering priority. That is, the SOC may determine the priority of the first device and the priority of the second device. The SOC may determine the mode types of the first device and the second device based on the priority of the first device and the priority of the second device.

The SOC may perform routing according to the mode type (operation S930). The SOC may determine the number of lanes according to the mode type and change the lanes of the plurality of devices according to the determined number of lanes. The SOC may increase the number of lanes of a higher-mode device among the plurality of devices. The SOC may decrease the number of lanes of a lower-mode device among the plurality of devices.

For example, the mode type for the first host of one of the plurality of devices may be a higher type, and the SOC may increase the number of lanes for the first host of one of the plurality of devices. The mode type for the second host of one of the plurality of devices may be a lower type, and the SOC may decrease the number of lanes for the second host of one of the plurality of devices. For example, the SOC may additionally allocate the third lane for the first host and one device. Accordingly, the first host may access one device through the first lane and the third lane among the plurality of lanes.

In some embodiments, the SOC may receive an offload command from the first host. The SOC may allocate a fourth lane among the plurality of lanes in response to the offload command. Accordingly, one device may access another device among the plurality of devices through the fourth lane.

In some embodiments, the SOC may perform routing according to the device type and the mode type. The SOC may identify device types of the plurality of devices. For example, the SOC may identify the plurality of devices based on at least one of an identifier of the plurality of devices and a command inputted to the plurality of devices.

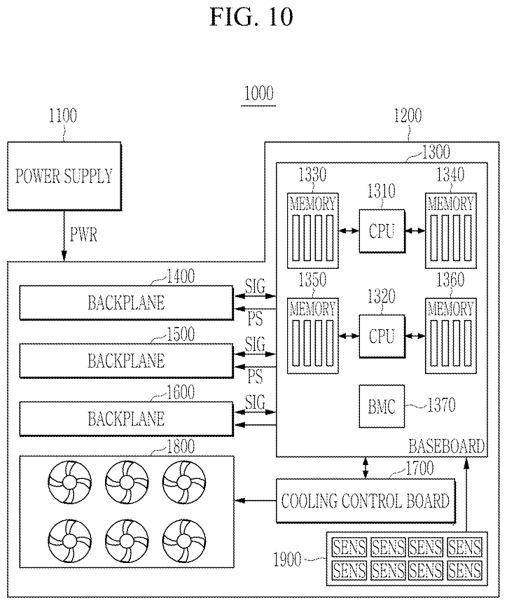

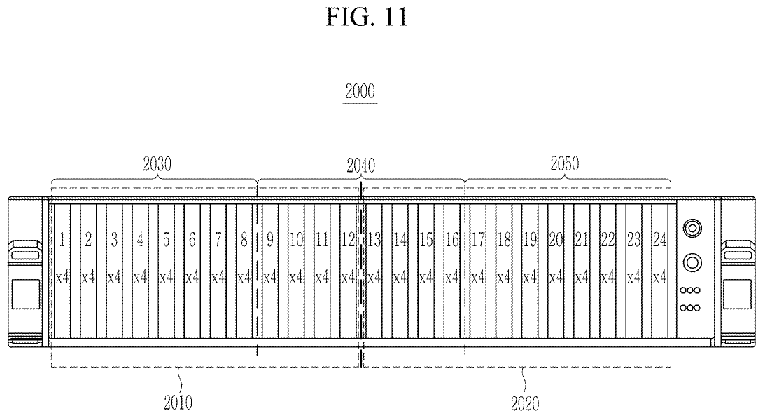

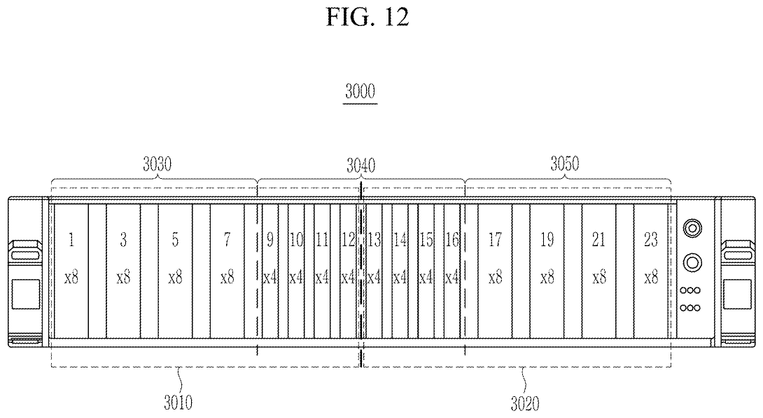

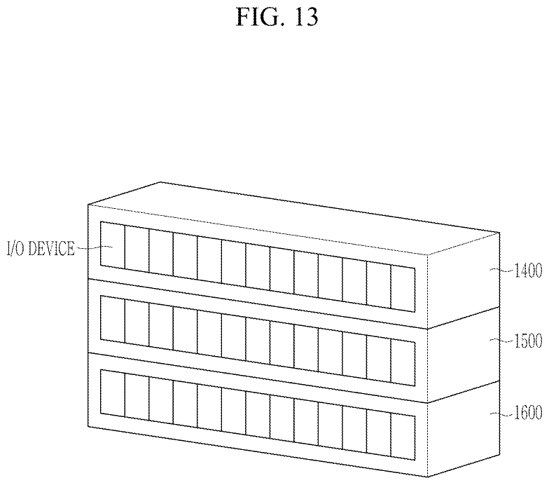

FIG. 10 illustrates a block diagram of an electronic device according to some embodiments, FIG. 11 and FIG. 12 respectively illustrate a chassis including electronic devices according to some embodiments, and FIG. 13 illustrates backplanes of an electronic device according to some embodiments.

Referring to FIG. 10, an electronic device 1000 may be a server. The electronic device 1000 may include a power supply 1100 and a power receiver 1200. The power supply 1100 may generate power PWR from an external power source (not shown), and may supply the generated power PWR to the power receiver 1200. The power PWR may be provided in the form of two or more different voltages (e.g., two or more different power signals having different voltages).

The power receiver 1200 may receive the power PWR from the power supply 1100 and may operate based on the power PWR. The power receiver 1200 may include a baseboard 1300, a first backplane 1400, a second backplane 1500, a third backplane 1600, a cooling control board 1700, coolers 1800, and sensors 1900.

The baseboard 1300 may include a first CPU 1310, a second CPU 1320, first memories 1330 and second memories 1340 connected to the first CPU 1310, third memories 1350 and fourth memories 1360 connected to the second CPU 1320, and a baseboard management controller (BMC) 1370. The baseboard 1300 may supply the power PWR received from the power supply 1100 to the first CPU 1310, the second CPU 1320, the first memories 1330, the second memories 1340, the third memories 1350, and the fourth memories 1360.

The first CPU 1310 may use the first memories 1330 and the second memories 1340 as operating memories. The second CPU 1320 may use the third memories 1350 and the fourth memories 1360 as operating memories. The memories 1330, 1340, 1350, and 1360 may be used as the main memory or system memory of the electronic device 1000. In some embodiments, the memories 1330, 1340, 1350, and 1360 may be dynamic random access memory (DRAM) devices and may have a form factor of a dual in-line memory module (DIMM). However, the present disclosure is not limited thereto, and the memories 1330, 1340, 1350, and 1360 may include a non-volatile memory such as a flash memory, a PRAM, an RRAM, and an MRAM.

In some embodiments, the CPUs 1310 and 1320 may be connected (e.g., directly connected) to the memories 1330, 1340, 1350, and 1360. In some embodiments, the memories 1330, 1340, 1350, and 1360 may directly communicate with the CPUs 1310 and 1320 through a DDR interface. In the embodiment, the CPUs 1310 and 1320 may include a memory controller configured to control the memories 1330, 1340, 1350, and 1360. However, the present disclosure is not limited thereto, and the memories 1330, 1340, 1350, and 1360 may communicate with the CPUs 1310 and 1320 through various interfaces.

The first CPU 1310 and the second CPU 1320 may execute an operating system and various applications. The first CPU 1310 and the second CPU 1320 may control constituent elements of the power receiver 1200. For example, the first CPU 1310 and the second CPU 1320 may control the constituent elements of the power receiver 1200 based on PCIe.

The first CPU 1310 and the second CPU 1320 may access the first backplane 1400, the second backplane 1500, and the third backplane 1600. For example, the first CPU 1310 and the second CPU 1320 may access the first backplane 1400, the second backplane 1500, and the third backplane 1600 based on an NVMe. The first memories 1330, the second memories 1340, the third memories 1350, and the fourth memories 1360 may include DIMM memories inserted into DIMM slots.

FIG. 11 in conjunction with FIG. 10 shows a chassis 2000 according to some embodiments. The chassis 2000 may include a third CPU 2010 and a fourth CPU 2020. The third CPU 2010 and the fourth CPU 2020 may be connected to the plurality of I/O devices by using different lane links in the chassis 2000. For example, the chassis 2000 may provide a first protocol 2030, a second protocol 2040, and a third protocol 2050.

The third CPU 2010 may be connected to the plurality of I/O devices by using the first protocol 2030 and a portion of the second protocol 2040. The fourth CPU 2020 may be connected to the plurality of I/O devices by using a portion of the second protocol 2040 and the third protocol 2050.

The first protocol 2030 may include first to eighth lane sets, and each lane set may include 4 lanes. The second protocol 2040 may include ninth to sixteenth lane sets, and each lane set may include 4 lanes. The third protocol 2050 may include seventeenth to twenty-fourth lane sets, and each lane set may include 4 lanes. The third CPU 2010 may use the first to twelfth lane sets, and the fourth CPU 2020 may use the thirteenth to twenty-fourth lane sets.

The first protocol 2030 and the second protocol 2040 may be different protocols. For example, the first protocol 2030 may be a protocol supporting PCIe and CXL, and the second protocol 2040 may be a protocol supporting PCIe. In addition, the second protocol 2040 and the third protocol 2050 may be different protocols. For example, the second protocol 2040 may be a protocol supporting PCIe, and the third protocol 2030 may be a protocol supporting PCIe and CXL.

FIG. 12 in conjunction with FIG. 10 shows a chassis 3000 according to some embodiments. The chassis 3000 may include a fifth CPU 3010 and a sixth CPU 3020. The fifth CPU 3010 and the sixth CPU 3020 may be connected to the plurality of I/O devices by using different lane links in the chassis 3000. For example, the chassis 3000 may provide a fourth protocol 3030, a fifth protocol 3040, and a sixth protocol 3050.

The fifth CPU 3010 may be connected to the plurality of I/O devices by using the fourth protocol 3030 and a portion of the fifth protocol 3040. The sixth CPU 3020 may be connected to the plurality of I/O devices by using a portion of the fifth protocol 3040 and the sixth protocol 3050.

The fourth protocol 3030 may include a first lane set, a third lane set, a fifth lane set, and a seventh lane set, and each lane set may include 8 lanes. The fifth protocol 3040 may include ninth to sixteenth lane sets, and each lane set may include 4 lanes. The sixth protocol 3050 may include a seventeenth lane set, a nineteenth lane set, a twenty-first lane set, and a twenty-third lane set, and each lane set may include 8 lanes. The fifth CPU 3010 may use the first lane set, the third lane set, the fifth lane set, the seventh lane set, and the ninth to twelfth lane sets, and the sixth CPU 3020 may use the thirteenth to sixteenth lane sets, the seventeenth lane set, the nineteenth lane set, the twenty-first lane set, and the twenty-third lane set.

Embodiments according to the present disclosure are not limited to the embodiment of the chassis 2000 or 3000 shown in FIG. 11 and FIG. 12, and additional embodiments such as adjusting the number of CPUs or adjusting the number of lanes may be possible.

The fourth protocol 3030 and the fifth protocol 3040 may be different protocols. For example, the fourth protocol 3030 may be a protocol supporting PCIe and CXL, and the fifth protocol 3040 may be a protocol supporting PCIe. In addition, the fifth protocol 3040 and the sixth protocol 3050 may be different protocols. For example, the fifth protocol 3040 may be a protocol supporting PCIe, and the sixth protocol 3030 may be a protocol supporting PCIe and CXL.

Returning to FIG. 10, the BMC 1370 may be a separate system separated from the operating system of the first CPU 1310 and the second CPU 1320. The BMC 1370 may collect information from the constituent elements of the electronic device 1000 and access the constituent elements. The BMC 1370 may be based on a separate communication interface separated from the communication interface (for example, PCIe) of the first CPU 1310 and the second CPU 1320. For example, the BMC 1370 may be based on an intelligent platform management interface (IPMI). The communication interface of the BMC 1370 may communicate with the communication interface of the first CPU 1310 and the second CPU 1320.

FIG. 13 shows an example in which the plurality of I/O devices are mounted on the first backplane 1400, the second backplane 1500, and the third backplane 1600. Referring to FIG. 13 in conjunction with FIG. 10, in order to reduce the size of the electronic device 1000, the plurality of I/O devices may be closely mounted on each of the first backplane 1400, the second backplane 1500, and the third backplane 1600. In addition, in order to reduce the size of the electronic device 1000, the first backplane 1400, the second backplane 1500 and the third backplane 1600 may be arranged in close contact with each other.

The first backplane 1400 may receive power PWR from the power supply 1100, exchange signals SIG with the baseboard 1300, and receive power signals PS. The first backplane 1400 may exchange the signals SIG with the first CPU 1310, the second CPU 1320, or the BMC 1370 of the baseboard 1300 and receive the power signals PS. The first backplane 1400 may include a plurality of I/O devices. That is, the first backplane 1400 may mount a plurality of I/O devices.

The plurality of I/O devices may be implemented as accelerators, memory devices, storage devices, network cards, or the like. For example, the accelerator may be implemented as a GPU, an NPU, a TPU, or the like that provides a computational function. The memory device is a DRAM, and may include a CXL DRAM that operates based on a PCIe interface. The storage device may include an HDD device or an SSD device. For example, the SSD device may be implemented as an NVMe SSD, a CXL SSD, a CXL computational SSD (also referred to as a smart SSD), and the like. The network card may be implemented as a NIC to provide a web search function. The first CPU 1310 and the second CPU 1320 of the baseboard 1300 may access the plurality of I/O devices of the first backplane 1400 through the signals SIG. For example, the first CPU 1310 and the second CPU 1320 may access the memory device and the storage device to perform write, read, and erase operations. The BMC 1370 of the baseboard 1300 may monitor the first backplane 1400 through the signals SIG, and may access and control the first backplane 1400. The first CPU 1310, the second CPU 1320, or the BMC 1370 of the base board 1300 may power-on or power-off the first backplane 1400 by using the power signals PS.

The first backplane 1400 may perform adaptive routing between the CPUs 1310 and 1320 and the plurality of I/O devices. For example, the first backplane 1400 may include a system on chip for performing adaptive routing. The system on chip may monitor traffic between the CPUs 1310 and 1320 and the plurality of I/O devices. The system on chip may determine a mode type corresponding to a connection between the CPUs 1310 and 1320 and the plurality of I/O devices according to the monitoring result. The system on chip may change at least one of the link speed and the link width according to the mode type. For example, the system on chip may change the number of lanes.

The second backplane 1500 and the third backplane 1600 have the same structure as the first backplane 1400, and may operate in the same way. Therefore, redundant descriptions thereof are omitted herein in the interest of brevity.

The baseboard 1300 may independently power on and power off the first backplane 1400, the second backplane 1500, and the third backplane 1600. Services supported using the first backplane 1400, the second backplane 1500, and the third backplane 1600 may be different from each other. While the electronic device 1000 does not provide a specific service, a backplane corresponding to the specific service may be powered off, and another backplane may be powered on.

For example, usage frequencies of services supported by the first backplane 1400, the second backplane 1500, and the third backplane 1600 may vary according to time zones. During times when the usage frequencies of services supported by the first backplane 1400, the second backplane 1500, and the third backplane 1600 are low, at least one of the first backplane 1400, the second backplane 1500, and the third backplanes 1600 may be powered off.

Returning to FIG. 10, the cooling control board 1700 may receive the power PWR from the power supply 1100. The cooling control board 1700 may control the coolers 1800 according to the control of the baseboard 1300. For example, the cooling control board 1700 may control the coolers 1800 according to the control of the first CPU 1310, the second CPU 1320, or the BMC 1370 of the baseboard 1300. The cooling control board 1700 may control operation activation and deactivation of the coolers 1800, and cooling intensity (for example, RPM) thereof.

The coolers 1800 may receive the power PWR from the power supply 1100. The coolers 1800 may perform cooling under the control of the cooling control board 1700 to lower the temperature of the electronic device 1000. The coolers 1800 may include fans, but the present disclosure is not limited thereto. The coolers 1800 are not limited to being concentrated and provided at one location, and may be distributed and provided at two or more locations. Some of the coolers 1800 may be attached to the chassis of the electronic device 1000 to flow outside air into the electronic device 1000. Some other of the coolers 1800 may be at a specific constituent element and may be dedicated to cooling the specific constituent element.

The sensors 1900 may receive the power PWR from the power supply 1100. The sensors 1900 may be adjacent to the constituent elements of the electronic device 1000. The sensors 1900 may collect various information under the control of the baseboard 1300 and provide the collected information to the baseboard 1300.

For example, the sensors 1900 may collect information under the control of the BMC 1370 of the baseboard 1300 and provide the collected information to the BMC 1370. The sensors 1900 may provide information collected through sensor data repository (SDR) of IPMI to the BMC 1370. For example, different record IDs may be allocated to the sensors 1900. The sensors 1900 may provide information to the BMC 1370 based on the different record IDs. The sensors 1900 may include various sensors such as a temperature sensor, a humidity sensor, a vibration sensor, and the like.

In FIG. 10, it is shown that a certain number of the CPUs and memories are mounted on the baseboard 1300, but the number of the CPUs and memories are not limited. Although a certain number of the backplanes are shown in FIG. 10, the number of backplanes is not limited. Although a certain number of the coolers of a specific type are shown in FIG. 10, the type and number of the coolers are not limited. Although a certain number of the sensors are shown in FIG. 10, the number and type of the sensors are not limited.

In some embodiments, each constituent element or a combination of two or more constituent elements described with reference to FIG. 1 to FIG. 13 may be implemented as a digital circuit, a programmable or non-programmable logic device or array, an application specific integrated circuit (ASIC), or the like.

While this disclosure has been described in connection with what is presently considered to be practical embodiments, it is to be understood that the disclosure is not limited to the disclosed embodiments, but, on the contrary, is intended to cover various modifications and equivalent arrangements included within the scope of the appended claims.

What is claimed is:

1. A routing method that is performed by a system on chip of a backplane connected between a plurality of hosts and a plurality of devices, the method comprising:
monitoring traffic of the plurality of devices;
determining mode types of the plurality of devices according to the monitored traffic; and
performing routing according to the mode types to allocate lanes between the plurality of devices and the backplane.

2. The routing method of claim 1, wherein the determining of the mode types includes determining a mode for each device of the plurality of devices to be a first mode or a second mode according to the monitored traffic thereof, and
wherein at least one of a link speed and a link width supported by the first mode is greater than or equal to at least one of a link speed and a link width supported by the second mode.

3. The routing method of claim 1, wherein the plurality of hosts includes a first host and a second host, and wherein the determining of the mode types of a first device of the plurality of devices is for the plurality of hosts and includes:
determining a mode type for the first host of the first device; and
determining a mode type for the second host of the first device.

4. The routing method of claim 1, wherein the performing of the routing includes:
determining a number of lanes to be allocated to each device of the plurality of devices according to the mode type determined therefor; and
changing lanes of the plurality of devices according to the determined number of lanes.

5. The routing method of claim 4, wherein the determining of the number of lanes includes increasing a number of lanes to be allocated to a device of a higher mode or decreasing a number of lanes to be allocated to a device of a lower mode, among the plurality of devices.

6. The routing method of claim 4, wherein the plurality of hosts include a first host and a second host, wherein a mode type for the first host of a first device of the plurality of devices is a higher type, and wherein the determining of the number of lanes includes increasing a number of lanes to be allocated for the first host of the first device of the plurality of devices.

7. The routing method of claim 4, wherein the plurality of hosts includes a first host and a second host,
wherein a mode type for the second host of one of the plurality of devices is a lower type, and
wherein the determining of the number of lanes includes decreasing the number of lanes for the second host of one of the plurality of devices.

8. The routing method of claim 1, wherein the monitoring traffic of the plurality of devices includes monitoring traffic directed from the plurality of hosts to the plurality of devices.

9. The routing method of claim 1, wherein the monitoring traffic of the plurality of devices includes detecting a first device and a second device having increased traffic among the plurality of devices, and
wherein the determining of the mode types of the plurality of devices according to the monitored traffic includes determining mode types of the first device and the second device as higher modes.

10. The routing method of claim 9, wherein the determining of the mode types of the first device and the second device as the higher modes includes determining the mode types of the first device and the second device to be the same.

11. The routing method of claim 9, further comprising determining a priority of the first device and a priority of the second device,
wherein the determining of the mode types of the first device and the second device as the higher modes includes determining the mode types of the first device and the second device based on the priority of the first device and the priority of the second device.

12. The routing method of claim 1, wherein the plurality of hosts include a first host and a second host accessing one device of the plurality of devices through a plurality of lanes, and
wherein the monitoring traffic of the plurality of devices includes monitoring traffic for the one device of the first host and traffic for the one device of the second host.

13. The routing method of claim 12, wherein:
the first host accesses the one device through a first lane of the plurality of lanes, and the second host accesses the one device through a second lane of the plurality of lanes, and
the monitoring of the traffic for the one device of the first host and the traffic for the one device of the second host includes monitoring traffic of the first lane and traffic of the second lane.

14. The routing method of claim 13, wherein the monitoring of the traffic of the first lane and the traffic of the second lane includes detecting an increase in traffic for the one device of the first host,
wherein the determining of the mode type includes determining a mode for the one device of the first host as a higher mode, and
wherein the performing of the routing includes additionally allocating a third lane so that the first host accesses the one device through the first lane and the third lane of the plurality of lanes.

15. The routing method of claim 13, further comprising:
receiving an offload command from the first host; and
allocating, in response to the offload command, a third lane of the plurality of lanes so that the one device accesses another device of the plurality of devices.

16. A system on chip, comprising:
a monitoring module configured to monitor traffic of a plurality of devices;
a mode setting module configured to determine mode types of the plurality of devices according to the traffic; and
a routing module configured to perform routing according to the determined mode types.

17. The system on chip of claim 16, wherein
the system on chip is on a backplane, and
the routing module is configured to perform routing to allocate lanes between the plurality of devices and the backplane.

18. The system on chip of claim 16, wherein the monitoring module is configured to monitor traffic directed from a plurality of hosts to the plurality of devices.

19. The system on chip of claim 16, wherein the plurality of devices include at least one of a CXL SSD, a CXL DRAM, and a smart SSD.

20. An electronic device comprising:
a plurality of hosts;
a plurality of input/output devices that are connected to the plurality of hosts to process commands received from the plurality of hosts; and
a system on chip that is configured to monitor traffic directed from the plurality of hosts to the plurality of input/output devices and is configured to change a lane link connecting the plurality of hosts and the plurality of input/output devices based on the monitored traffic.
